(19) United States
(12) Patent Application Publication
(10) Pub. No.: US 2003/0041539 A1
(43) Pub. Date: Mar. 6, 2003

(54) Door or wall window insert frame and method

(76) Inventors: Daniel R. Bernacki, Coralville, IA (US); Douglas K. Kidd, Keller, TX (US)

Correspondence Address: MCKEE, VOORHEES & SEASE, P.L.C., 801 GRAND AVENUE, SUITE 3200, DES MOINES, IA, 50309-2721, US

(21) Appl. No.: 10/229,589

(22) Filed: Aug. 27, 2002

Related U.S. Application Data
(60) Provisional application No. 60/315,723, filed on Aug. 28, 2001.

(51) Int. Cl. E06B 3/30; E06B 3/00; E02D 27/42

(52) U.S. Cl. 52/204.54

(57) ABSTRACT

An apparatus, method and system for a window assembly for insertion into an opening in a window supporting structure including, but not limited to, a building wall or door, or a mobile or automotive vehicle. Frame pieces are adapted to fit into opposite sides of the opening and be releaseably secured into position without the window glazing or any insert in place. This allows the frame pieces to be installed by one person. The frame pieces are translatable relative to one another over a range to accommodate different thickness openings. A glazing or insert can independently installed in a frame piece. Securing structure can be adapted to accommodate different thickness glazing or inserts.

### INCORPORATION BY REFERENCE

The entire contents of U.S. Provisional Application No. 60/315,723, filed Aug. 28, 2001, is incorporated by reference herein in its entirety.

### I. BACKGROUND OF THE INVENTION

A. Field of the Invention

The present invention relates to window frames, and in particular, to window frames that are insertable and securable in doors, walls, or similar structures, particularly solid or insulated exterior doors.

Furthermore, the present invention relates to a new and unique design of a window system, for application in, among other things, steel insulated garage doors.

B. Problems in the Art

A wide variety of ways exist to support a window in a retaining structure, such as a door, wall, or similar structure. Many methods utilize a window framework that is built into, or is part of the structure of the retaining structure for the window, with the intention that it last for a substantial number of years. For example, windows for residences are normally customized for the window opening in the wall, are robust, and are installed very securely; and neither the pane nor the framework are readily removable. Removal or repair usually requires substantial effort, labor and time. They also tend to be quite costly to manufacture and to purchase. Many door windows are also essentially permanently installed.

Some types of windows, however, need to be less costly or durably secured. One example, can be garage door windows. While it is desirable that they be reasonably durable, the cost is a factor, and as a result, they are not generally as robust as the framework and installation of house windows or permanently mounted door windows.

A conventional way to mount garage door windows in typical panel-type garage doors for residential use involves a two piece frame system (interior frame for the interior side of the garage, and exterior frame for the exterior side of the garage) applied to a door panel, in which one or both of the components are configured and uniquely designed for a very specific door thickness and glazing thickness. As is well known in the art, there is a variety of different garage door thickness and a variety of choices of glazing thickness. If, for example, there exists within a door product series three different door thickness selections (e.g. 1″, 1⅜″ and 2″), and glazing is offered in several thickness selections (e.g. ⅛″ thick or ½″ thick), as is sometimes required, typical products would be offered that include one exterior frame component and six interior frame components. For the door retailer, this requires keeping an inventory of at least various interior frame components. A further disadvantage is that if there is variation in either the glazing thickness or the door panel thickness along its length or height, the frame assembly may be unable to successfully accommodate the variations, without sacrificing the secure fit of the glazing and/or the frame system within the door, or leading to possibly damaging excess pressure on some parts of the door or glazing, due the nature of the design.

Further disadvantages of the present conventional designed products are the cumbersome, time-consuming manner in which glazing is removed/replaced within the frame, as in the case of broken glazing. Typically, the entire frame assembly must be disassembled, either utilizing two people while the door remains assembled or possibly utilizing one person if the door is disassembled completely. Retrofitting the glazing commonly takes place while the glazed door panel is on a separate workbench.

Moreover, many types of conventional window frames for garage doors are either essentially permanently installed and, therefore, very difficult to remove or repair, or are not very robust and do not hold up well, especially over time.

Therefore, there is a real in the art for improvement in economical window frames, not only for garage doors, but other retaining structures.

### II. BRIEF SUMMARY OF THE INVENTION

A. General Invention

The present invention includes an apparatus, method and system for a window frame which includes an interior subframe and an exterior subframe. The interior and exterior subframes include facing sides that cooperate with securing devices adapted to hold the interior and exterior subframes against separation from one another over a range of distances. In one embodiment, the interior and exterior subframes have portions that generally matingly engage one another in a slideable or telescopic fashion, such that the window frame presents a generally perimeter enclosure, but allows adjustment of the installed distance between interior and exterior subframes so the framework, without the need to substitute a different size or configured interior or exterior subframe. The frame can be installed into panels (doors, walls, etc.) of a range of thickness. Structure on the subframes can be used to secure the entire window frame in an appropriately sized opening in a door, wall or other retaining structure, regardless of the thickness, if within said range of thickness. In one embodiment, such structure is one or more flanges extending from at least part of the perimeter of the interior and exterior subframes which can be used to clamp the surfaces on opposite sides of the door or other retaining structure into which the window frame is installed.

In another aspect of the apparatus according to the invention, one of said interior and exterior subframes can include a receiver for receiving a pane of glazing and including securing structure to secure the glazing in place. The securing structure can be adapted or adjusted to secure glazing or other inserts of a variety of thickness. In one embodiment, the securing structure is one or more clips removably installable, spaced apart around the glazing, and adapted to both secure the glazing against movement out of the receiver and exert clamping forces against the glazing for a secure seating in the receiver. Different clips can be used for different thickness of glazing, or other securement devices can be used.

Still further, the framework can be optionally adapted to removably receive a decorative insert or other type of insert sized for positioning in or on an interior or exterior subframe. In one embodiment, the insert is a simulated cross frame or muntin bars, placeable over one side of the glazing.

A method according to the present invention includes providing opposing subframes of a window frame which can be adjustably secured in installed position over a range of distances relative to one another. A glazing or other insert into the windrow frame can be removably secured by clamping action or other securement methods. Different thickness glazing can be accommodated.

A system according to the present invention includes an exterior and interior subframe combination or set, installable into an opening in a supporting structure for a range of thickness for the supporting structure, a seat in one of the subframes for a glazing or other insert, and one or more securing members for securing the subframes relative to one another in installed position. The securing member allowing securement of the subframes relative one another. In one embodiment, a plurality of sets of securing members are manufactured or configurable, each set useful for a different thickness retaining structure. One or more securing members releasably secure glazing or another insert to a receiver in the subframe combination. In one embodiment, a plurality of sets of securing members for the glazing or other insert can be manufactured or configured, each set useful for a different thickness of glazing or other insert.

B. Objects, Features and/or Advantages of the Invention

It is therefore a principal object, feature or advantage of the present invention to improve over or solve problems and deficiencies in the state of the art.

Further objects, features, and/or advantages of the present invention include the provision of an apparatus, method or system which:

a. Provides good stability and durability for a window.

b. Is difficult to misalign.

c. Removably secures in place.

d. Is relatively easy to disassemble and assemble.

e. Is efficient and economical

Additional objects, features, or advantages of the invention include the following. One set of components may be used for any door thickness within the designated size range, and any glazing thickness for which glazing retention clips are developed, typically ⅛″ and ½″ thick, eliminating duplicate costly inventory.

Glazing may be easily installed or removed from the frame system, before, during or after assembly of the frame system within the door panel, by a single person, saving time, and returning a door and window to full operation promptly.

Further objects, features, or advantages of the present invention will become apparent with reference to the accompanying description and drawings.

### III. BRIEF DESCRIPTION OF THE DRAWINGS

FIG. 1A is a isolated front perspective assembled view of an exemplary embodiment of the invention as the window assembly would be viewed from externally of a garage.

FIGS. 1B is an perspective view of the opposite side of the embodiment of FIG. 1A.

FIG. 2A is a front elevation view of the embodiment of FIG. 1A.

FIG. 2B is a sectional view taken along line A-A of FIG. 2A.

FIG. 2C is an enlarged isolated fragment view of the indicated portion of FIG. 2D.

FIG. 2D is a sectional view taken along line B-B of FIG. 2A, for a first garage door thickness and with a glazing of a first thickness.

FIG. 2E is a sectional view taken along line B-B of FIG. 2A, for a second garage door thickness and a glazing of the first thickness.

FIG. 2F is a sectional view taken along line B-B of FIG. 2A, for the first garage door thickness but a glazing of a second thickness.

FIG. 3A is a front elevation view of a first subframe portion of the embodiment of FIG. 1A.

FIG. 3B is a sectional view taken along line A-A of FIG. 3A.

FIG. 3C is an enlarged isolated fragment view of the indicated portion of FIG. 3B.

FIG. 3D is a side view of FIG. 3A, taken in the direction of line B-B of FIG. 3A.

FIG. 3E is a sectional view taken along line B-B of FIG. 3A.

FIG. 4A is a back elevation view the first subframe of FIG. 3A.

FIG. 4B is an enlarged side plan view of a clip used with the embodiment of FIG. 1A, for a first glazing thickness.

FIG. 4C is an enlarged side plan view of a clip used with the embodiment of FIG. 1A, for a second glazing thickness.

FIG. 4D is a front elevation view of the clip of FIG. 4C.

FIG. 4E is a reduced in size side plan view similar to FIG. 4C.

FIG. 4F is a top plan view of the clip of FIG. 4E.

FIG. 4G is a right side view of the clip of FIG. 4E.

FIG. 4H is a left side view of the clip of FIG. 4E.

FIG. 4I is a bottom view of the clip of FIG. 4E.

FIG. 5A is a front elevation view of a second subframe of the embodiment of FIG. 1A, as it would be seen from internally of a garage.

FIG. 5B is a sectional view taken along line A-A of FIG. 5A.

FIG. 5C is an enlarged isolated fragment detail view of the indicated portion of FIG. 5A.

FIG. 5D is an enlarged isolated fragment detail view of the indicated portion of FIG. 5B.

FIG. 5E is a side view from the direction of the bottom of FIG. 5A.

FIG. 5F is a sectional view taken along line B-B of FIG. 5A.

FIG. 6 is an reduced in size exploded view of the assembly of FIG. 1A relative to a garage door or other supporting structure into which the assembly can be installed.

### III. DETAILED DESCRIPTION OF AN EXEMPLARY EMBODIMENT OF THE INVENTION

A. Overview

For purposes of a better understanding of the invention, one exemplary embodiment of the same will now be described in detail. It is to be understood that this is but one form the invention can take, and is given for illustration only. Variations obvious to those skilled in the art are included within the scope of the invention.

When describing this example of one way to make and use the invention, frequent reference will be taken to the appended drawings. Reference numbers will be used to indicate certain parts or locations in the drawings. The same reference numbers will indicate the same parts or locations throughout the drawings, unless otherwise indicated.

This example will be described in the context of a conventionally sized window (e.g. 18″ wide by 12″ tall) for a conventional sectional garage door (between 1″ and 2″ thick) for a residential garage, having a steel front and back, and insulation in-between (basically a solid panel with an appropriate sized opening for the window). Conventional glass panes of between ⅛″ and ½″ thickness are useable with the window.

However, it is to be understood that the exemplary embodiment can be used with other panels of similar thickness in which windows are desired, including but not limited to RV wall panels, pick up truck caps, building panels, partitions, doors of various types (interior or exterior), automotive, commercial or agricultural vehicles and the like.

B. General Structure

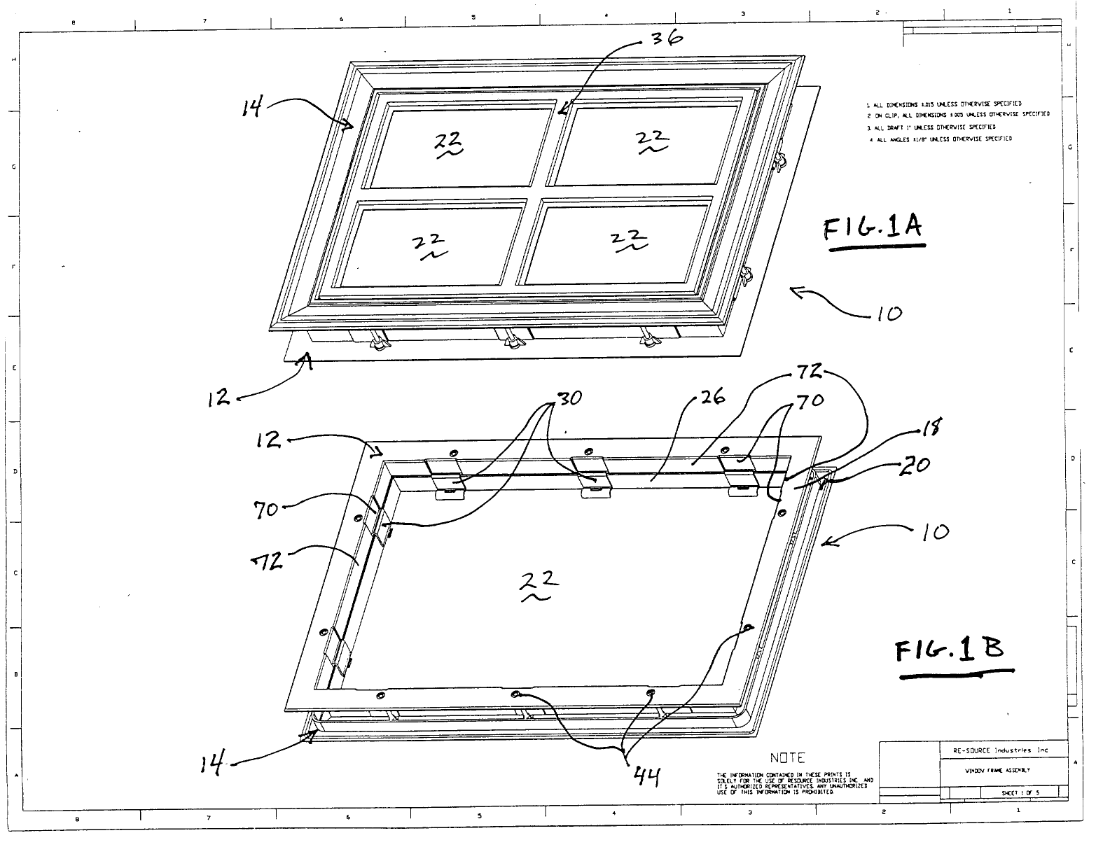

FIGS. 1A and B illustrate an embodiment of a window frame (indicated generally at reference number 10) in accordance with the invention in assembled form by showing top and bottom perspective assembled views. Frame 10 includes an exterior subframe (see generally 12) and an interior subframe (see generally 14) which generally mate together and are held by screws 16 in the generally adjacent and parallel position shown. Outward extending flanges 18 and 20, of subframes 12 and 14 respectively, form opposite clamping surfaces which abut opposite sides of a garage door. The subframes can be secured together over a range of positions, and thus, by appropriate drawing together of subframes 12 and 14, flanges 18 and 20 clamp frame 10 to a garage door.

Frame 10 is a multi-piece injection molded plastic window frame system for use in garage door panels. Subframes 12 and 14 can be made of PVC (UV stable, weatherable, exterior grade).

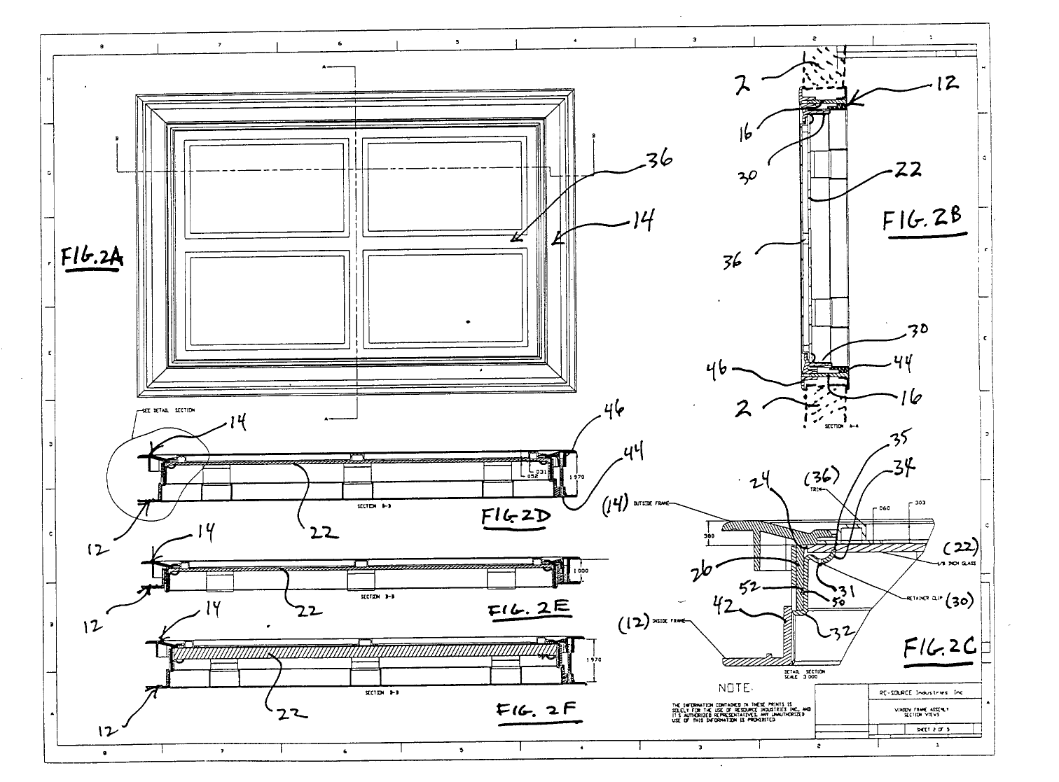

Frame 10 receives glazing 22, one side of which seats against a ledge 24 (see FIG. 2C) smaller in perimeter dimensions than glazing 22 and bounded by a generally perpendicular wall 26. Ledge 24 and wall 26 define what will be called a receiver for glazing 22 which holds glazing 22 against movement in any direction except back out from the receiver. Removable clips 30 have a u-shaped portion 32 that fits, in inverted fashion, over wall 26 and releasably locks in place, and an outwardly extending leg portion 34 configured to extend over and exert pressure against glazing 22, when glazing 22 is seated in the receiver.

Recesses 70 in inward facing walls 72 of interior subframe 12 allow passage of clips 30 and serve as guides for installation of clips 30 to eliminate misalignment. Non-recessed portions of inward facing walls 72 serve as a retainer for exterior subframe 14.

A decorative insert 36, such as simulated muntin bars, snaps in and out of exterior subframe 14 from the outside of subframe 14. In frame 10, insert 36 can also be assembled from the inner side of exterior subframe 14, as will be discussed in more detail later.

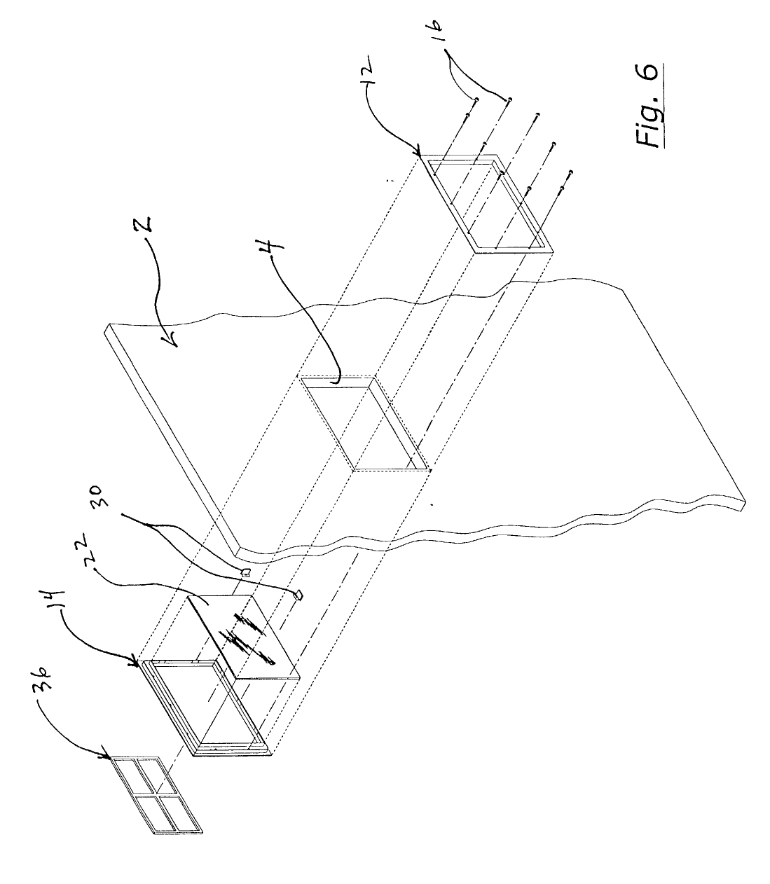

FIG. 6 shows frame 10 in exploded form relative to a garage door 2 (only a portion of which is illustrated from simplicity) having an opening 4 between inner face 6 and outer face 8, with insulation 9 therebetween.

FIG. 6 is a diagrammatical view illustrating an important aspect of frame 10. Exterior subframe 14 includes the receiver for glazing 22 as well as receives insert 36 independently of assembly with interior subframe 12. Thus, one person can easily assemble, disassemble, repair, modify or otherwise work with frame 10, including glazing 22 and insert 26, usually without removing garage door 2 from its tracks, need of assistance, or special tools. Glazing 22 can be securely mounted into exterior subframe 14 at a worksite, such as a table or workbench; as can insert 36. Exterior subframe 14 is fittable from the outer facing side of garage door 2 into opening 4, interior subframe 12 is brought from the inner face side of garage door 2 into opening 4, and subframes 12 and 14 are brought together by screws 16 until flanges 18 and 20 abut inner and outer faces 6 and 8 of garage door 2, to clamp frame 10 in place.

Furthermore, with frame 10, insert 36 can be snapped in and out of recess or channel in exterior subframe 14, from the outer side of garage door 2, because insert 36 is made of a material that is somewhat flexible (e.g. plastic). This can be done without any disassembly of subframes 12 and 14.

As shown in FIG. 1, when assembled, flanges 18 and 20 are relatively smooth and flush to the garage door. The structure of frame is firmly secured to garage door 2. It has the appearance of a one piece frame.

C. Detailed Structure and Operation

FIGS. 2A-F illustrate in more detail the interaction of subframes 12 and 14. The sectional views show how subframe 12 and subframe 14 are matingly and slideably adjustable relative to one another. Wall 26 of exterior subframe 14 fits within wall 42 of interior subframe 12.

As shown in FIGS. 2D-F, subframes 12 and 14 can be adjusted for securement to a thicker garage door 2 (e.g. approximately 2″ thick in FIGS. 2D and 2F) or a thinner door 2 (approximately 1″in FIG. 2E). Interior subframe has a plurality of through-holes 44 from its outer face to its inner face through which screws 16 can be positioned. Exterior subframe 14 has corresponding pre-molded or pre-drilled bosses 46 on its inner face. Screws 16 have self-tapping threads and bite into the material defining holes to secure subframes 12 and 14 together. As shown in FIGS. 2D-F the length of screws 16 is selected to correspond to the thickness of door 2 to which frame 10 is being attached. Therefore, different sets of screws 16 (of different lengths) will be pre-manufactured for use with different thickness doors.

FIGS. 2D-F also illustrate how frame 10 can accept different thickness glazing 22. In FIGS. 2D and E, glazing 22 is approximately ⅛″ thick. In FIG. 2F, glazing 22 is approximately ½″ thick. In each case, glazing 22 is received by and seats into the receiver defined by ledge 24 and wall 26 on the inner side of exterior subframe 14. Different sized clips 30 are used for different thickness glazing. Legs 34 of clips 30, as can be seen in FIGS. 2D and E, are closer to outer end of u-shaped portion 32 of clips 30 than in the version in FIG. 2F because glazing 22 in FIGS. 2D and E is thinner than in FIG. 2F.

FIG. 2C shows additional detail on how clips 30 secure glazing 22 in place. On the inner face of the part of u-shaped portion 32 to which leg 34 is attached is a bar or catch 50. Bar or catch 50 snaps into and mates with a corresponding slot 52 in wall 26 of exterior subframe 14 when clip 30 is in place. This prevents clip 30 from moving back out. U-shaped portion 32 prevents lateral movement of clip 30, as well as prevents movement of clip 30 closer to subframe 14. Locating ribs 53 also serve to guide and prevent misalignment of clips 30 when being installed.

Leg 34 of clip 30 is intentionally formed so that when in a normal position and installed on wall 26 with bar 50 snapped into slot 52, its distal end 35 extends past the plane of where the closest face of glazing 22 would be, if glazing 22 was installed. Thus, when glazing 22 is installed and bar 50 is engaged in slot 52 to prohibit movement of clip 30, distal end 35 of leg 34 would be forced to flex away from its normal position. Clip 30 is made of a material which has some flex but is resilient and tries to return to its normal position. Leg 34 would therefore exert force against glazing 22. Therefore, by this arrangement, clips 30 not only hold glazing 22 in place, but exert pressure against it for a secure fit, regardless of some variations in thickness of glazing 22 or other tolerance issues.

Clip 30 can be made of PVC. Other materials are possible. Nylon and steel are examples. The strength and resiliency of clip 30 are sufficient to withstand 40-60 psi of wind load against glazing 22 without failure.

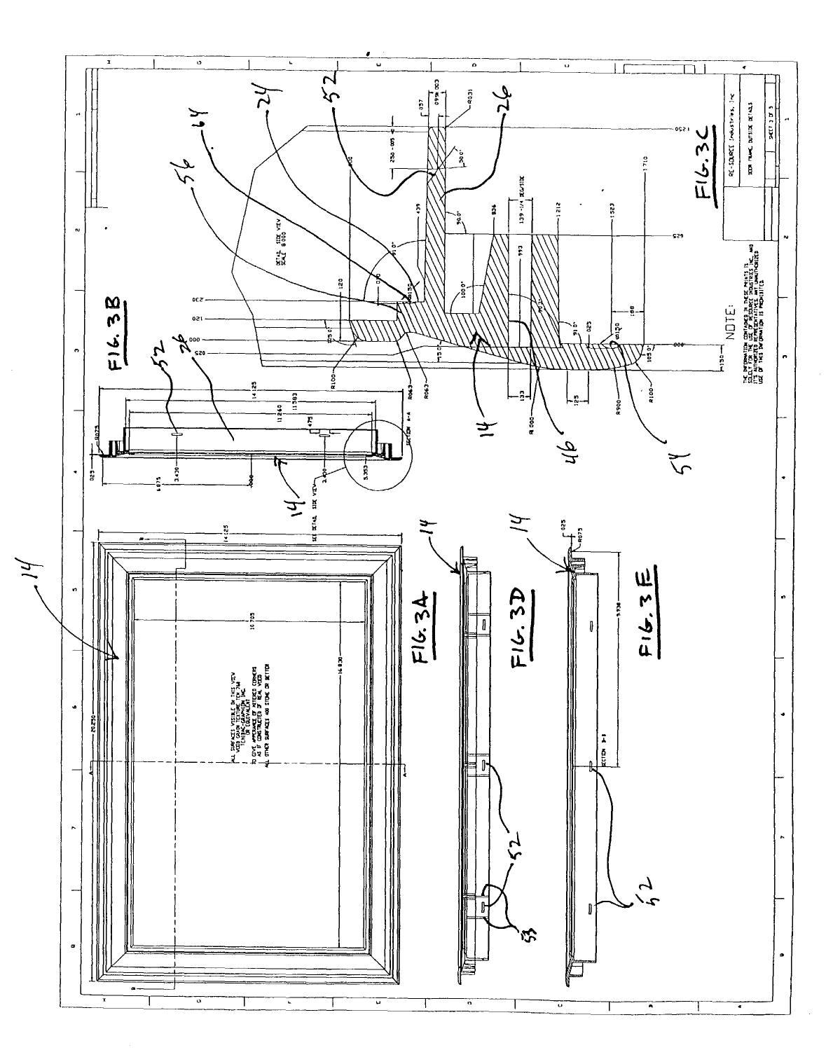

Figures FIGS. 3A-E illustrate the structure of exterior subframe 14 in more detail, primarily from the vantage point of looking at its outer side. In particular, the structure of holes 46, for receipt of self-cutting screws 16, is shown. Also, channel 56, for receipt of perimeter flange 58 of insert 36, is shown. Still further channel 54, for retaining or assisting in retaining a gasket or bead of caulking for sealing flange 20 of exterior subframe 14 to the outer face 8 of garage door 2, is shown. FIGS. 3B, D, and E show in more detail slots 52 for receipt of bars 50 of clips 30.

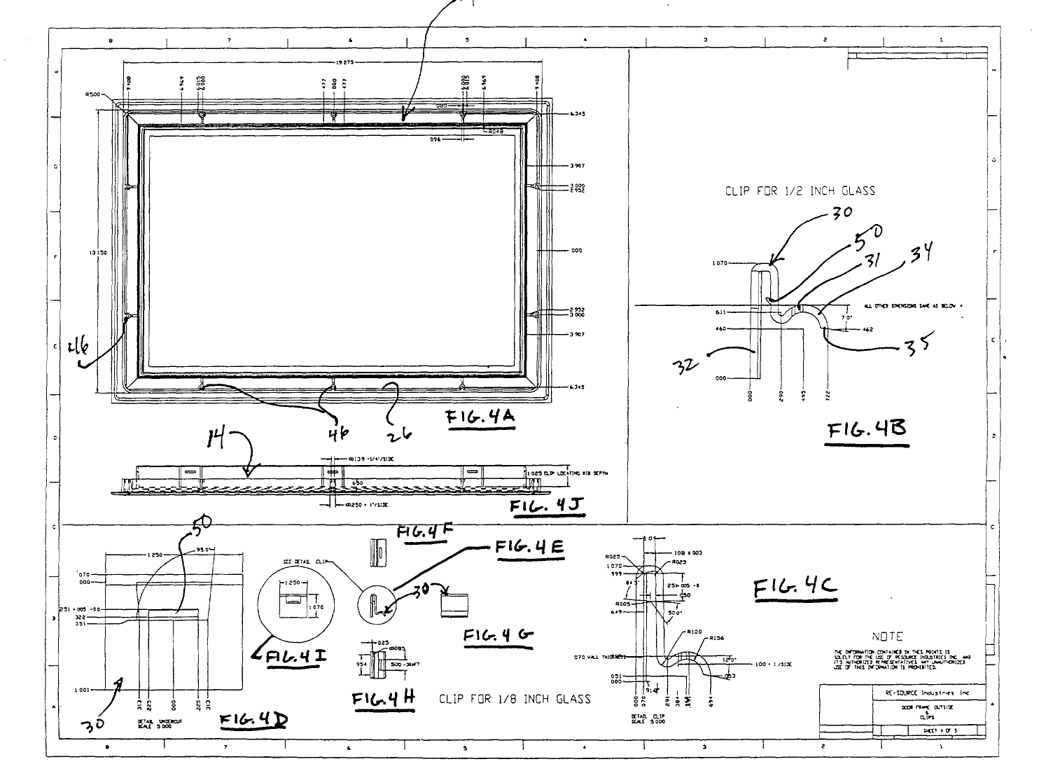

FIGS. 4A and J show exterior subframe 14 in isolation and detail primarily from its inner side.

FIGS. 4B-I show clip 30 in more detail (FIGS. 4C-I for ⅛″ glass and FIGS. 4B for ½″ glass respectively). FIGS. 4D-I show clips 30 from different perspectives for a more complete understanding of their structure.

Clips 30 allow selected glazing material 22 to be secured in or removed from exterior subframe independent of any interaction with interior subframe 12. Glazing clip 30 is designed to be positively located on and engaged with exterior subframe in such a manner as to secure clip 30 and the glazing material 22 within exterior subframe, sufficient to prevent glazing 22 from becoming loose or inadvertently uninstalled from frame 10. Clips 30 and exterior subframe 14 have corresponding male/female alignment groove (reference number 52) and bar (reference number 50) elements on the inside of clip 30 and on wall 26 of exterior subframe 14 which locate clip 30 in the proper position on wall 26. By sliding clip 30 down on exterior subframe 14 in such properly aligned position, clip 30 then positively engages with exterior subframe 14. The engagement is of a male engagement “tooth” 50 on clip 30, and a female engagement slot 52 inner facing side of wall 26 of exterior subframe 14. Glazing 22 is retained in place by the retention leg 34 of clip 30. Retention leg 34 is designed in such a way as to allow proper compression force to be applied to glazing 22 while increasing the pressure on the engagement tooth system (members 50 and 52), further stabilizing the engagement/retention functions of clip 30. Multiple clips 30 are evenly spaced around wall 26 of exterior subframe 14 to accomplish the securing of glazing 22 within frame 10.

Glazing clip 30 is further designed in such a way that, in the event the glazing must be removed, clips 30 can be manually disengaged from exterior subframe 14 and removed, allowing removal and replacement of the glazing. This can be easily accomplished by inserting a flat end tool, similar to a flat end or blade end screwdriver into slot 31 in leg 34 of clip 30, then applying force to clip 30, away from the wall 26 of exterior subframe 14, facilitating “opening” of clip 30 and disengaging it from the exterior subframe engagement tooth 50. Clip 30 may then be removed from exterior subframe 14 by reversing the installation direction; sliding clip 30 up and off of wall 26 of subframe 14. Glazing 22 can then be removed and replaced. The original clips (or replacement clips, if needed) may be reinstalled on exterior subframe 14 in the manner outlined above.

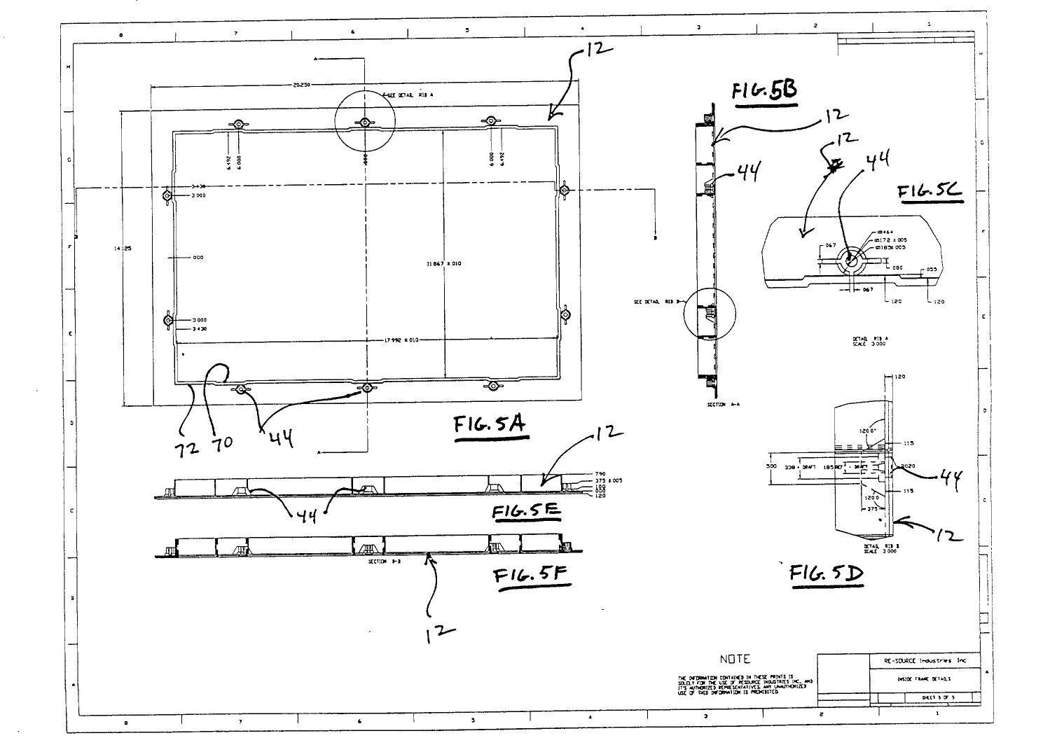

FIGS. 5A-F are views of primarily the inner side of interior subframe 12. Interior subframe 12 is designed to assemble/mate with exterior frame 14 by sliding on/around the primary sidewall 26 of exterior frame 14. This may take place with the glazing and glazing retention clips 30 installed in exterior frame 14 or not. Interior subframe 12 makes contact with the inner surface 6 of insulated door panel 2. The exterior and interior subframe components are designed to allow the two parts to telescope together at any door thickness within the designed size range of the specified parts.

In the illustrated configuration, the door thickness range allows use of frame 10 on doors from 1″ to 2″ in thickness, measured from the point of contact of exterior subframe 14 with the outer face 8 of door 2, and interior subframe's 12 contact with inner face 6 of door 2. Doors with a larger thickness can be accommodated by use of an interior subframe designed identical to the initial part design, except for part depth, which would be increased to accommodate a greater door thickness range from, for example, 2″-3″ in door thickness.

Attachment of interior subframe 12 to exterior subframe 14, and thus the securing of the entire frame/glazing system 10 within the door panel 2, is accomplished with specified screws or other in-line fastening method. Such screws will be inserted through the interior subframe at recessed screw holes 44 in the face of interior subframe 12, and directly into mating screw bosses 46 formed within the body of exterior subframe 14 at locations corresponding with the screw holes 44 in interior subframe 12.

Frame 10 therefore presents a window insert system where one set of interior and exterior subframes can be used for a variety of door thickness, and a variety of thickness of glazing, and/or optional inserts. It does not require inventory of multiple frame components for different door or glazing sizes. Different sized sets of screws 16 and clips 30 are easier and cheaper to maintain. The system is economical and efficient to manufacture, assemble, disassemble, use and repair. It is flexible in its application.

D. Alternatives/Options

It will be appreciated that the present invention can take many forms and embodiments. The included preferred embodiment is given by way of example only, and not by way of limitation to the invention. Variations obvious to one skilled in the art will be included within the invention. The true essence and spirit of this invention are defined in the appended claims, and it is not intended that the embodiment of the invention presented herein should limit the scope thereof.

For example, dimensions and configurations of the components of the preferred exemplary embodiment have been set forth in the above description and also in the appended figures. Variations are of course possible.

Likewise, different materials are possible, as are different configurations to accomplish the same functions.

Because of the design of the system, two basic frame components may be used on any door thickness (multiple door models within a product line) within the designated size range of the frame system, and will accept a variety of glazing thickness (e.g. ⅛″ or ½″) in any application the frame is used without additional components beyond those described.

Users may add or remove glazing quickly and easily at any point before, during or after assembly of the frame within a door, without complicated and time consuming disassembly of the exterior and interior frame components. The glazing removal and replacement is a “one person” task, as compared to conventional systems which require two people, or the disassembly of the glazed door section from the door, and removal/replacement of the frame on a work bench type environment.

The nature of the system design eliminates multiple frame components from a user's inventory, since one set of parts has broad application. Currently designed and used parts are produced specific to one door thickness and one glazing thickness. Frame assembly requires positive contact with both the door interior skin and the glazing interior surface by the interior frame in order for the frame and glazing components to be securely held in place within the door.

The exterior frame of the system may be configured (as presented) to additionally accept the installation of plastic insert design trim within the exterior subframe and in front of the glass.

The system according to the invention can be configured in different sizes for use in typical insulated industrial commercial overhead doors. The only difference in the design will be the elimination of the channel in the exterior frame in which plastic insert design trim is installed the version of FIG. 1. All other aspects would remain essentially the same. Additionally, a glazing retention clip designed to accommodate ¼″ thick glazing can be developed for use in either version.

A design variation allowing application of the common exterior frame and glazing clips on a non insulated steel pan type door, and an open back insulated steel pan type door are also possible. Such variations would differ from the core design in the manner in the configuration of the interior frames, allowing application on the door types indicated while retaining the advantages of the glazing clip feature.

What is claimed is:

1. A window frame assembly for installation into an opening in a support structure having a thickness for a window comprising:
(a) an interior subframe having distal and proximal opposite sides;
(b) an exterior subframe having distal and proximal opposite sides:
(c) the interior and exterior subframes including portions which are adapted to cooperate with securing devices adapted to hold the interior and exterior subframes against separation from one another over a range of distances;
(d) so that the assembly can be installed and removably secured in openings in support structure of different thickness.

2. The assembly of claim 1 wherein the interior and exterior subframes have portions that generally matingly engage one another in a slideable fashion.

3. The assembly of claim 1 wherein the interior and exterior subframes have portions that generally matingly engage one another telescopically.

4. The assembly of claim 1 wherein the subframes, when mated present a generally perimeter enclosure adapted for installment into an opening in a supporting structure, but allows adjustment of the installed distance between interior and exterior subframes without the need to substitute a different size or configured interior or exterior subframe for different thickness supporting structures.

5. The assembly of claim 1 wherein the different thickness is a range of thickness.

6. The assembly of claim 5 wherein the range of thickness is between approximately a fraction of an inch to several inches.

7. The assembly of claim 1 wherein the supporting structure is a building.

8. The assembly of claim 8 wherein the supporting structure is a building wall.

9. The assembly of claim 7 wherein the building is a garage.

10. The assembly of claim 9 wherein the building is a garage and the supporting structure is a garage door for the garage.

11. The assembly of claim 1 wherein the supporting structure is mobile.

12. The assembly of claim 11 wherein the supporting structure is automotive.

13. The assembly of claim 1 further comprising structure on the subframes can be used to secure the entire window frame in an appropriately sized opening in a door, wall or other retaining structure, regardless of the thickness, if within said range of thickness.

14. The assembly of claim 13 wherein said structure is one or more flanges extending from at least part of the perimeter of the interior and exterior subframes which can be used to clamp the surfaces on opposite sides of the door or other retaining structure into which the window frame is installed.

15. The assembly of claim 1 wherein one of said interior and exterior subframes can include a receiver for receiving an insert and further including securing structure to removably secure the insert in place

16. The assembly of claim 15 wherein the insert is glazing.

17. The assembly of claim 15 wherein the insert is a window pane.

18. The assembly of claim 15 wherein the insert is a decorative insert.

19. The assembly of claim 15 further comprising securing structure adapted to secure a said insert of a variety of thickness.

20. The assembly of claim 19 wherein the securing structure comprises one or more clips removably installable, spaced apart around the glazing, and adapted to both secure the insert against movement out of the receiver and exert clamping forces against the insert for a secure seating in a receiver in a subframe.

21. The assembly of claim 20 further comprising different clips can be used for different thickness of glazing.

22. The assembly of claim 1 further comprising a sub-framework adapted to removably receive a decorative insert or other type of insert sized for positioning in or on an interior or exterior subframe.

23. The assembly of claim 22 wherein the insert insert comprises a simulated cross frame or muntin bars, placeable over one side of a glazing.

24. A system for installing a removable window in structure supporting the window comprising:
(a) a set of first and second members installable and releasably securable into an opening in the structure, for a range of thickness for the supporting structure, by one or more reversible securing members;
(b) a seat in one of the members for independent removable installation and releasable securement by one or more securing members, for a range of thickness, a glazing or other insert.

25. The system of claim 24 wherein the first and second members are mateable frames, when mated defining a window opening.

26. The system of claim 25 wherein first and second members are telescopically mateable relative one another.

27. The system of claim 26 wherein the first and second members comprise laterally extending portions of perimeter dimensions larger than the opening in the supporting structure, and adapted to abut and clamp opposite sides of the supporting structure when converging force is applied to the first and second members.

28. The system of claim 27 wherein the securing members comprise structure adapted to hold the first and second members against separation forces when mated together.

29. The system of claim 28 wherein the securing members are separable from the first and second members.

30. The system of claim 28 wherein the securing members are self-tapping screws.

31. The system of claim 24 wherein one of the first and second members comprise a plastic material.

32. The system of claim 24 wherein the securing member for the glazing or other insert is separable from the first or second member.

33. The system of claim 32 wherein the securing member is a clip having resilient properties.

34. The system of claim 33 further comprising a plurality of sets of securing members, each set useful for a different thickness retaining structure.

35. The system of claim 34 further comprising a plurality of sets of securing members for the glazing or other insert, each set useful for a different thickness of glazing or other insert.

36. A method for releasably installing a window assembly including window frame and glazing or insert into an opening in a supporting structure for the window comprising:
(a) positioning frame pieces on opposite sides of the opening in the supporting structure without the glazing or insert installed;
(b) telescopically mating and releasably securing the frame pieces in the opening;
(c) inserting and releasably securing the glazing or insert in one of the frame pieces.

37. The method of claim 36 further comprising removing the glazing or insert independently of the frame pieces by reversing a releasably securing member.

38. The method of claim 37 further comprising removing the frame pieces by reversing a releasably securing member.

39. The method of claim 36 further comprising securing the frame pieces to an opening having a cross sectional thickness from a range of cross sectional thickness.

40. The method of claim 36 further comprising securing the glazing or insert having a cross sectional thickness from a range of cross sectional thickness.

41. The method of claim 36 wherein the frame pieces are secured by converging forces.

42. The method of claim 36 wherein the glazing or insert is secured by clamping action.
